(19) United States
(12) Patent Application Publication
(10) Pub. No.: US 2017/0323074 A1
(43) Pub. Date: Nov. 9, 2017

(54) On-Demand All-Points Telemedicine Consultation System and Method

(71) Applicant: Michael CHIANG, Frisco, TX (US)

(72) Inventor: Michael CHIANG, Frisco, TX (US)

(21) Appl. No.: 15/585,147

(22) Filed: May 2, 2017

Related U.S. Application Data
(60) Provisional application No. 62/332,449, filed on May 5, 2016.

(51) Int. Cl. G06F 19/00; G06F 21/60; H04L 29/06; H04N 7/14

(52) U.S. Cl. CPC G06F 19/3418; H04N 7/147; H04L 63/0815; G06F 19/322; H04L 63/08; G06F 21/602; G06Q 2220/10

(57) ABSTRACT

An on-demand all-points telemedicine (APTM) system for a patient presenting site (PPS) includes a patient data server configured to store encrypted patient electronic medical records, a web server configured to store web pages of a web portal, and APTM equipment disposed in patient presenting sites. The APTM equipment includes a microprocessor executing an APTM application, a communication interface configured to interface with the patient data server and the web server, a video camera that captures video and still images and sound, a display screen that displays video and still images and electronic medical record data, patient examination/monitoring devices, and a user interface device that receives user input. The APTM system employs an application for execution on a computing device and configured for communicating with the plurality of APTM equipment and the patient data server to exchange electronic medical records, still and video data, messages, and control data.

### RELATED APPLICATION

This application claims the benefit of U.S. provisional patent application Ser. No. 62/332,449 filed on May 5, 2016.

### FIELD

The present disclosure relates to the field of telemedicine, and in particular, to an on-demand all-points telemedicine (APTM) consultation and rounding system and method.

### BACKGROUND

At many medical institutions, there is a gap in trust between the on-call hospitalists and emergency room (ER) doctors. The gap is worsened by different financial, work flow, and organizational priorities between the ER doctors and hospitalists. Ideally, the ER doctors want all ER patients admitted to the hospital patient floor as soon as the patient qualifies under a predetermined set of “admission criteria.” Prolonged patient stay in the ER creates further ER congestion and work load on the ER staff. Nursing staff and doctors have to manage these ER patients and thus diverting resources away from treating other ER patients. The hospitalists, however, are typically not in a hurry to rush to the ER to admit patients as they are not rewarded financially for speed. The hospitalists often take their time and find a convenient time to come to the ER or come to the hospital to take care of several admissions at one time. The hospitalist's preference of making the fewest number of trips to the hospital to care for patients is in conflict with the ER staff's desire to move patients out of the ER as soon as possible. This scenario plays out in most hospitals all over the United States. Further, the on-call doctors would frequently disagree with the ER doctor's justification for hospital admission for a given patient. Often there is disagreement on whether in-patient care is warranted for the patient or can the patient be discharged to go home with close follow-up with a visit to see the consultant/specialist in office. Doctors often prefer to see patients in the clinic where the flow and efficiency of seeing/billing for patient care is much higher.

### BRIEF DESCRIPTION OF THE DRAWINGS

FIG. 1 is a simplified block diagram of an exemplary embodiment of an on-demand all-points telemedicine consultation system according to the teachings of the present disclosure;

FIG. 2 is a simplified data flow diagram of an exemplary embodiment of an on-demand all-points telemedicine consultation method according to the teachings of the present disclosure;

FIG. 3 is a simplified data flow diagram of an exemplary embodiment of an on-demand all-points telemedicine consultation method according to the teachings of the present disclosure;

FIG. 4 is a simplified data flow diagram of another exemplary embodiment of an on-demand all-points telemedicine consultation method according to the teachings of the present disclosure;

FIG. 5 is a simplified data flow diagram of an exemplary embodiment of an on-demand all-points telemedicine rounding method according to the teachings of the present disclosure;

FIG. 6 is a simplified flowchart of an exemplary embodiment of an on-demand all-points telemedicine consultation registration method according to the teachings of the present disclosure;

FIG. 7 is a simplified flowchart of an exemplary embodiment of an on-demand all-points telemedicine consultation method according to the teachings of the present disclosure;

FIG. 8 is another simplified flowchart of an exemplary embodiment of an on-demand all-points telemedicine consultation method according to the teachings of the present disclosure; and

FIG. 9 is a simplified block diagram of an exemplary embodiment of on-demand all-points telemedicine consultation equipment according to the teachings of the present disclosure.

### DETAILED DESCRIPTION

An on-demand “all-points” system and method linking “all doctors” affiliated with patient care at a medical/clinical facility, such as a hospital emergency room, a free-standing ER, an urgent care facility, a micro-hospital, a chiropractic facility, a nursing home, to enable them to see and treat patients via telemedicine at the medical facility (ER, ICU, and regular floor units) in an on-demand basis offer tremendous advantages over the current conventional practice in hospitals and other medical facilities. These medical/clinical facilities where patients are present are also hereinafter called patient presenting sites (PPS). A PPS that adopts the on-demand all-points telemedicine (APTM) system of patient-centric care-delivery offers better patient care, improved patient outcome, higher patient satisfaction, and greater safety and effectiveness of medical treatment. The doctors appreciate the mobility and freedom because they can be productive tending to patients bedside to engage face to face patient assessment and consultation at any time anywhere, while engaging in other professional or personal activities. On-demand APTM also addresses the tension between ER doctors and in-patient hospitalists and other specialists, and in turn offers higher efficiency and productivity. This directly translates to better and more expeditious patient care, and improved work flow for the entire hospital/medical facility. A natural result of instituting on-demand APTM is higher revenue for the PPS.

The “point of engagement” between the patient and the appropriate specialist/hospitalists at the PPS is often delayed due to rationing of resources determined by financial interests of the medical institutions or physicians with limited availability of resources. This delay in physician engagement results in lowered quality of medical care. APTM offers patients a higher quality of service by providing the right care, at the right time, at the right place. APTM allows the earlier engagement of specialists/physicians to any PPS while utilizing lesser resources for its application. This alters the current practice of medicine by enabling the earlier engagement of specialist/hospitalists/staff which offers many advantages in medical (quality) care.

In addition to the trust gap between ER doctors and hospitalists described above, there is also another important factor at play. Specialists/consultants have limited liability in their patient treatment recommendation as they have never established a patient-physician relationship with the ER patient. This is because there was never a direct patient contact between the specialists/hospitalists/consultants and the ER patient. If an ER patient experiences a bad outcome, the specialist/consultant often cites as reason that inaccurate or incomplete clinical information that forms the basis for the medical diagnosis and decision was conveyed verbally by the ER doctor. This is why some medical centers record all phone calls between the ER doctor and the specialist consultants to improve accountability. This is an on-going and complex issue in ERs across the nation.

On the flip side, the ER doctor may request admitting patients who do not necessarily warrant hospital admission due to lack of experience and to protect him/herself from any liability for discharging patients. The in-patient doctors often criticize the inaccuracies of the ER doctor's diagnosis and treatment and erupt into a full blown departmental feud as a result. This gap is widened by those ER doctors who exaggerate the severity of the patient's condition to avoid a debate with the on-call doctor about patient disposition. Over time, the lack of accuracy between what was described by the ER doctors and what actually were the patient's true clinical conditions deepens the mis-communication and distrust even more. The on-going battle between the appropriateness of medical care between the ER doctors and the specialist/consultants/hospitalists is almost as historic and deeply-rooted. As a result of these issues, there are much distrust and animosity between the ER doctors and specialist/consultants/hospitalists.

On-demand all-points telemedicine (APTM) in the ER is the solution to these problems. APTM offers the consultants face-to-face direct patient care service that has equal efficacy (in published medical literature) of evaluating the ER patient “by consultation” as if the consultants were physically present in the ER. On-demand APTM allows the consultants to offer the most accurate medical recommendations based on APTM as the most accurate ability to collect actual patient condition without being physically present in the ER. On-demand APTM makes possible The Right Care at the Right time at the Right Place. Right Care—because it is based on the most accurate clinical information face-to-face without physically being there. Right time—because the consultants can be by the bedside in the ER rapidly without the need to waste time on travel. Literally beaming the consultants to the bedside in the ER. From the patient's perspective, the patient can benefit from the timely access to the consultant's specialized expertise while still in the ER. Since the ER patient does NOT have to wait for a specialist to arrive at the hospital, the best medical treatment ordered by the specialist would be delivered in the ER in the most timely and efficient manner. Right place—the most appropriate medical treatment ordered by the consultants can be started “in the ER” within minutes of the patient's arrival at the ER.

By using on-demand APTM, the specialist/consultant can better evaluate the patient and gather clinical information to arrive at a more accurate diagnosis and offer appropriate recommendations. The specialist/consultant can also personally observe the patient's color, expression, behavior, and ask questions. As a result, all parties bear full accountability since the consultant is able to engage the patient face-to-face via telemedicine, which is considered an acceptable means for the establishing a patient-physician relationship according to TMBE (Texas Medical Board of Examiner). The ER patients thus benefit from On-demand APTM-based care as they have access to and are seen and treated by on-call specialists/consultants in a timely manner.

Currently, the ER doctors often recommend follow-up visits to see the consultants within 24 to 48 hours. However, patients often come to realize that they could not get an appointment to see the consultants within that time frame. If the delay to see the consultants were to happen and ends in a bad outcome for the patient, it is arguable whose liability this would fall under with the current model. With APTM, since the consultants are fully liable for the patient's care, if his/her office impedes follow-up care, the consultant would be fully liable for his/her actions.

For a free-standing ER (FSER), the use of On-demand APTM to enable specialist consults enhances patient care and adds tremendous value to patient visits. The costs for APTM specialist care may be absorbed by the FSER to offer better service and value in patient care. This is possible in the free-standing ER business model because the total sum (from both professional services and facility fees of an ER) collected for each ER visit (private insurance) typically is sufficient to cover the costs of reimbursing the specialists for their time to see the patients and still cover all expenses at the ER. This type of business setup is probably only possible in an ER service setting where the reimbursement for ER care service is still significantly higher than most outpatient clinic/office reimbursement by insurance companies. This is further complicated because insurance reimbursement for professional services by physicians via telemedicine is currently not reimbursable in Texas, among many other states, in urban areas. Thus, trying to figure out who to pay for professional/doctor's telemedicine services in the city is one of the biggest obstacle for proliferation of telemedicine services in the country. The ability to pay for specialists to be on call for a free-standing ER allows such medical facilities to offer top quality multi-specialty consultation and care that were previously only enjoyed at major metropolitan medical centers.

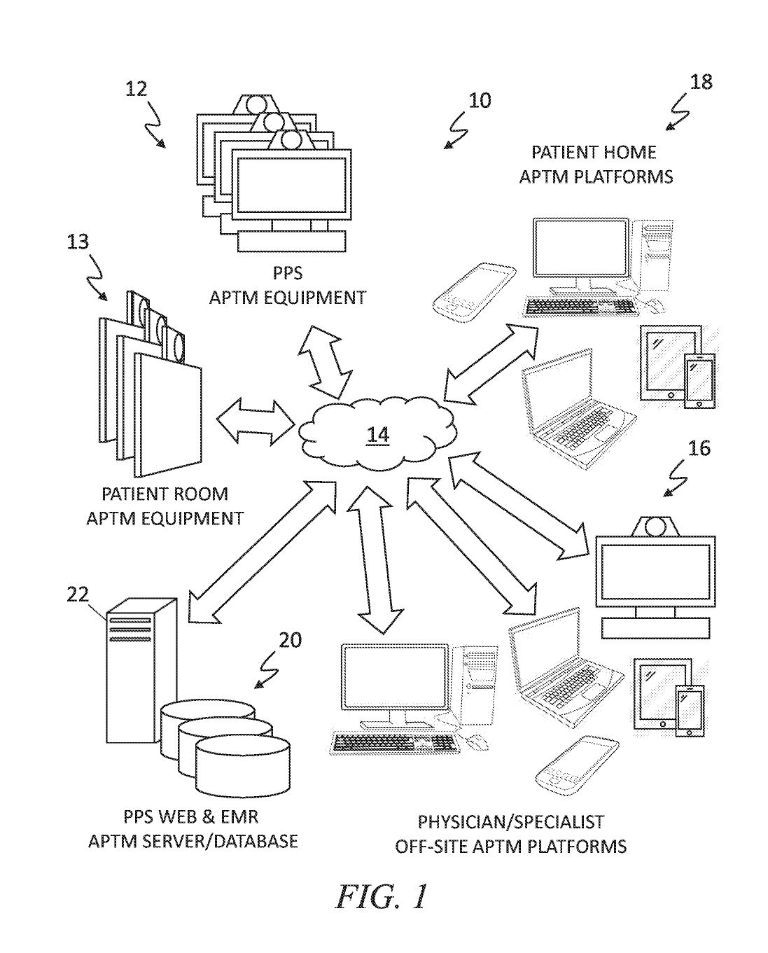

FIG. 1 is a simplified block diagram of an exemplary embodiment of an on-demand all-points telemedicine consultation and rounding system 10 according to the teachings of the present disclosure. In the hospital ER, ICU, and patient rooms, as well as free-standing ER or clinics (collectively referred to as examples of patient presenting sites or PPS), all-points telemedicine (APTM) equipment 12 are installed or available to enable APTM sessions with physician consultants and specialists (e.g., Cardiology, Pulmonary and Critical care specialists, Dermatology, Neurology, Psychiatry, Occupational Medicine/Physiatry, Ophthalmology, Oromaxillary facial surgery, Pediatric Emergency Medicine, Hematology, and Oncology). Patients' rooms may also be equipped with APTM equipment 13. The APTM equipment 12 and 13 enable two-point or multi-point HIPPA-compliant high-definition video conferencing, transmission and receipt of patients' electronic medical records (EMR), as well as transmission and receipt of multimedia messages between all points via the cloud 14 (i.e., Internet and telecommunication networks) using communication protocols currently known or to be developed. And peripheral telemedicine devices including stethoscope, scopes, portable camera, EEG monitoring device, and other devices. All the doctors are connected to the hospital telemedicine equipment 12 via an app that they download to their computing and mobile devices 16 (e.g., mobile phone, tablet computer, laptop computer, desktop computer) or simply log on APTM platform/server using any web browser that allows them to access all APTM apparatus in the ER, ICU, all applicable patient rooms (PPS), and even allow follow-up sessions with patients using their own APTM computing devices 18 after they have been discharged and resting at home.

Currently dedicated telemedicine equipment with a wide array of functionality is readily available. The typical telemedicine equipment includes a computing device, video camera, one or more display monitors, keyboard, and physiological measurement devices incorporated on a mobile cart. However, telemedicine heretofore has never been utilized extensively in a systematic and organized manner described in this disclosure.

The traditional telemedicine model is for the doctor to be sitting in front to a telemedicine device and for the patient to be “prepared” for the telemedicine experience. The reality is that it is not practical and resource-efficient to have the consultant to be sitting in front of the camera all day long waiting for telemedicine consults to occur. The consultants can be mobile and stay highly productive in health care with APTM being able to deliver of their expertise on-demand while on the go using mobile devices running an APTM mobile app.

The system 10 may incorporate an APTM web-based portal that enables physician consultants and specialists to use the APTM mobile app to initiate an all-points telemedicine session with the APTM equipment 12 in the hospital. The web portal pages as well as patient EMR data may be stored in databases 20 and accessible by one or more servers 22 in communication with the APTM equipment 12, 16, 18 and mobile apps. The consultant can be “beamed in” to any PPS, including patient room in the hospital, as well as into the ER, ICU, nursing homes, etc.

The system 10 is HIPPA-compliant to ensure patient privacy. This means that the users (doctors) identity needs to be verified and the patients' identity also needs to be identified at the hospital. The patients' identity can be further verified by the certified medical staff at the patient's bedside for simplicity. The APTM app running on the consultant's APTM device 16 authenticates the doctor's identity and connects with the PPS APTM equipment 12.

The end-user can control the configuration of the display layout, such as enlarge any portion of the display to zoom in on anything on the screen. The APTM encounter may be recorded for medical record transcription, for documentation purposes, or used to quickly create an EMR for the APTM visit. The APTM visits may be recorded and stored in databases 20 as part of the patient's EMR in case there is a need to review the interaction for various medical or legal reasons. The patient data stored in the databases 20 are encrypted to ensure HIPPA compliance and patient privacy.

Other medical personnel such as nurses, social workers, etc. may also utilize the APTM system 10 to pop-in and out of hospital rooms without the need to physically walk to all the patient rooms to perform a large set of services. The use of APTM system 10 thus may increase the work efficiency for all hospital medical staff.

The patient's family members may also be given access the APTM system 10 from their own personal computing devices so they can visit and re-visit with the patient remotely from home and still feel engaged with the care of the patient. This system and method 10 allow the patient's family to connect meaningfully without being in the room all the time. This feature/service makes any hospital equipped with the APTM system 10 very patient-friendly, and ensures high patient and family satisfaction for the hospital service/stay.

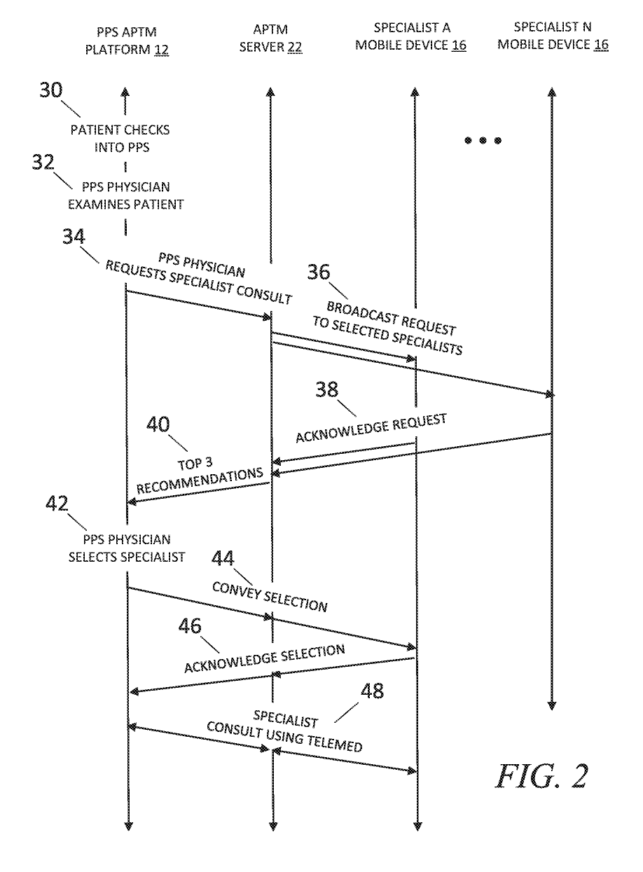

FIG. 2 is a simplified data flow diagram of an exemplary embodiment of an all-points telemedicine consultation method according to the teachings of the present disclosure. A patient checks into a medical facility or PPS, 30, and a physician examines the patient, 32. The physician determines that a specialist is needed for the proper evaluation and treatment of the patient, and requests a specialist consultant, 34. The physician enters type of specialist that is needed. The physician may accomplish this by initiating an APTM process on the PPS APTM platform 12. Alternatively, the physician may initiate the request using the APTM mobile app on his/her mobile device. A notification, such as a text message or a call may be sent by the medical staff through the hospital APTM system to the specialist by using APTM equipment 12 and 13 located either at the nurse's station or bedside. Alternatively, the notification may be sent via a mobile device. The on-demand APTM request is transmitted to the APTM server 22, which broadcasts the request to specialists that have been registered for on-demand APTM consultation that are of the requested specialty, 36. Specialists receive the request on their mobile devices 16, and those who are capable of providing consultation at this time acknowledge the request, 38. It should be noted that the specialist's identity and HIPPA-compliance are confirmed by strict implementation of state of the art security and authentication procedures. The acknowledgement may indicate how readily the specialist can provide the consultation. The APTM server 22 receives the acknowledgements and provides a predetermined number of top specialists as recommendations, 40. For example, the recommendation may identify those specialists that can immediately provide consultation. The physician then selects a specific specialist from among the recommended specialists, 42. The selection is conveyed by the APTM server 22 to the selected specialist, 44. The selected specialist then responds to the selection with an acknowledgement, 46. Thereafter, the on-demand APTM consultation session can be initiated, 48.

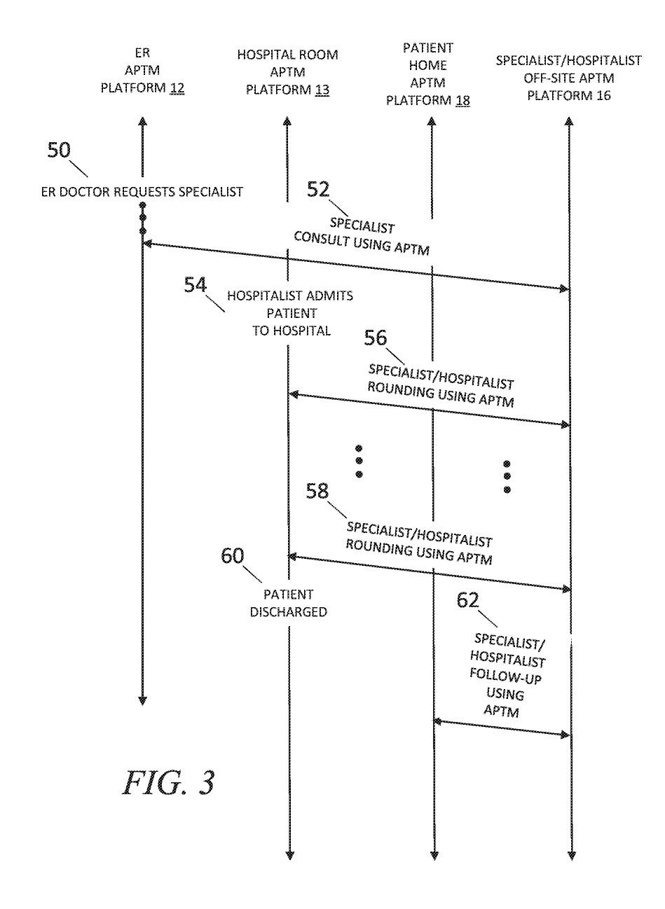

FIG. 3 is a simplified data flow diagram of an exemplary embodiment of a telemedicine consultation and rounding method according to the teachings of the present disclosure. The ER doctor may request consultation with a specialist for a patient, 50, and a consultation session is initiated, 52. The specialist performs the consultation using an APTM app running on his/her own computing platform 16, and may view and observe the patient, access the patient's ERM, and obtain the patient's current vitals and other clinical measurements and lab results. The patient and the specialist may also converse to enable the specialist to ask pertinent questions related to the patient's health condition. In this instance, the specialist's assessment is that the patient's condition warrants admission to the hospital, 54. Subsequently, the specialist/hospitalist may perform rounding and check on the patient in his/her hospital room by using APTM sessions one or more times, 56-58. The patient's family may also communicate with the patient using the APTM system. When the patient is well enough to be discharged, 60, the specialist/hospitalist may still follow-up with the patient at home using the APTM system, 62.

With on-demand APTM, the specialists are able to see the patients very quickly upon arrival to the hospital floor/room from the ER via APTM. The patients' clinical condition can be re-assessed repeatedly and effortlessly by the consultants by using APTM. This translates to much enhanced quality of care. If new specialists are consulted by the hospitalists, the newly consulted specialists may also beam in and evaluate the patient quickly—all providing a much higher level of medical care/service. A higher efficiency in medical diagnosis and treatment results from using the on-demand APTM system. Since the hospitalists can beam in “periodically and repeatedly” to check on their patients in an efficient fashion from anywhere they choose, a patient can receive multiple visits a day to ensure that the patient is recovering well. Both the doctor and the patients all would benefit by the convenience of on-demand APTM service.

Accordingly, a proposed on-demand APTM work flow follows: a notification message, conveyed by a call, text message, or some other form of communication is sent to one or more specialists via the APTM system 10. The urgency of the consult is preferably communicated in this message, so the specialists who received the notification can determine whether he/she can fulfill the on-demand APTM request. The specialist may respond and participate in the APTM session using any computing device/platform 16 that is capable of executing the APTM app. For remotely initiated on-demand APTM sessions, the remote specialist/hospitalist can easily access the APTM equipment in each patient room by identifying the room number and/or patient's name they want to visit. The remote specialist/hospitalist may need a prior permission or acknowledgement from the patient to beam in to the patient's rooms to avoid moments when the patient is not ready for consults. This can be done by the RN at the bedside with a click of a button to allow the specialist/hospitalist to appear in APTM connection. The presence of an APTM presenter by the bedside is helpful to moderate and provide guidance to enable smooth communications between the specialist/hospitalist and the patient.

The APTM system 10 may permit more than one doctor to attend to a patient during the same APTM session. When APTM is accessed by more than one person, the designated doctors calling-in has top priority and dispel any other caller already on the APTM connection in the room. When multiple doctors are calling in and sharing the images on the display screen, the display in the patient's room would be subdivided to display all the doctors who are sharing/accessing the APTM system in the room. All participants in the APTM session can hear and see each other on the screen. After the doctor completes a APTM visit, he can activate the EHR with one-click and start charting the content of the APTM visit wither by voice recording/transcription or documentation by texting/typing on a template or simply by saved video/audio recording of the visit. The EHR is then loaded into the system as part of the patient's medical record. The video recording may be stored as part of the patient's EMR.

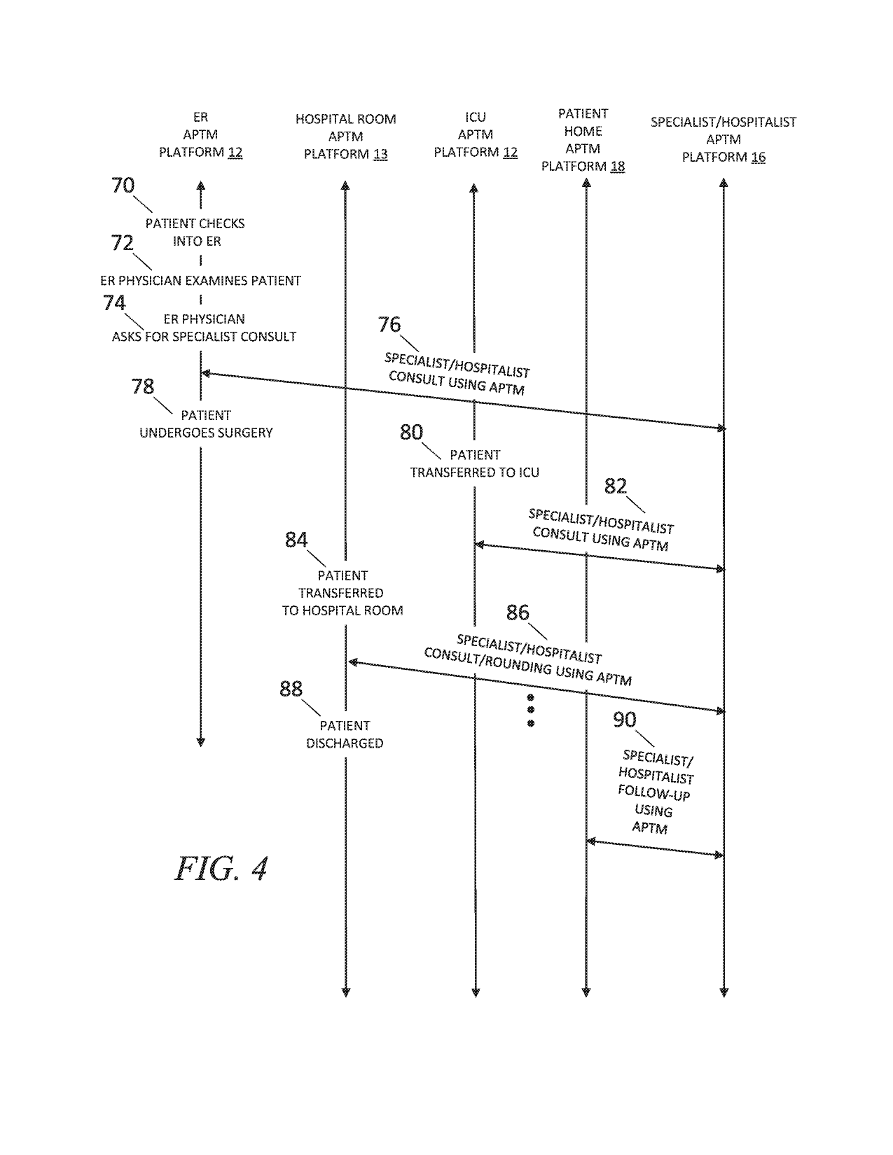

FIG. 4 is a simplified data flow diagram of another exemplary embodiment of a telemedicine consultation method according to the teachings of the present disclosure. A patient presents in the ICU and is examined by an ER physician, 70 and 72. The ER physician assesses the patient's conditions and decides to request for a consult with a specialist, 74. An on-demand APTM session is initiated and conducted between the ER physician and a specialist, where the specialist may use any computing device that is capable of executing the APTM app to conduct the session, 76. As a result of the consultation with the specialist, it is determined that the patient needs surgery, 78. The patient is then transferred to the ICU post-surgery, 80. If at any time the attending physician needs consultation with the surgeon, APTM may be used to immediately communicate with the surgeon to take advantage of the surgeon's knowledge and expertise, 82. Again, after the patient is transferred from the ICU to a hospital room, 84, APTM may be used for rounding and consultation, 86. After the patient is well enough to be discharged from the hospital, 88, follow-up visits may be done over APTM so that the patient doesn't have to expend time and energy to travel to the doctor's office, 90.

In the ICU, physicians often have to respond to critical “code blue” activations. Many of these patients are complexed post-op patients. For example, the cardiologists, pulmonologists, and the thoracic surgeons who have worked on the patient know the patient's condition very well. The thoracic surgeon may be keenly aware of all the intricacies and the difficulties during the operation, so when something goes wrong later in the ICU with their post-op patients, they often can offer very valuable insight as to what may be the possible reasons for the patient's deterioration—i.e. certain bleeding complications or difficulties during surgery with grafting blood vessels, etc. Therefore, it is very helpful (enhance the quality of care) if the surgeons and cardiologists who are responsible for the patient's care can “beam in” and see the patient's condition in the ICU using on-demand APTM. With near immediate engagement of the specialists who can offer near immediate recommendations of necessary treatments using APTM, the ICU care can be greatly enhanced when compared to the existing model. The specialists can control the cameras and zoom in on anything they want to see in the ICU room. They can speak with clarity to whoever is in the room and issue treatment orders to the staff. Again, the patient benefits from the right care at the right time at the right place.

The APTM system 10 may be used where an entire team of medical staff are activated to attend to a particular patient or medical issue. For example, when a heart attack patient is first in contact by emergency medical service (EMS) personnel, the entire heart attack team can be mobilized by using the APTM system 10 so cardiologists can engage in patient care during initial EMS-patient contact in the field. Further the entire cardiac catheterization lab team members can be notified and mobilized in preparation for the patient's arrival at the hospital.

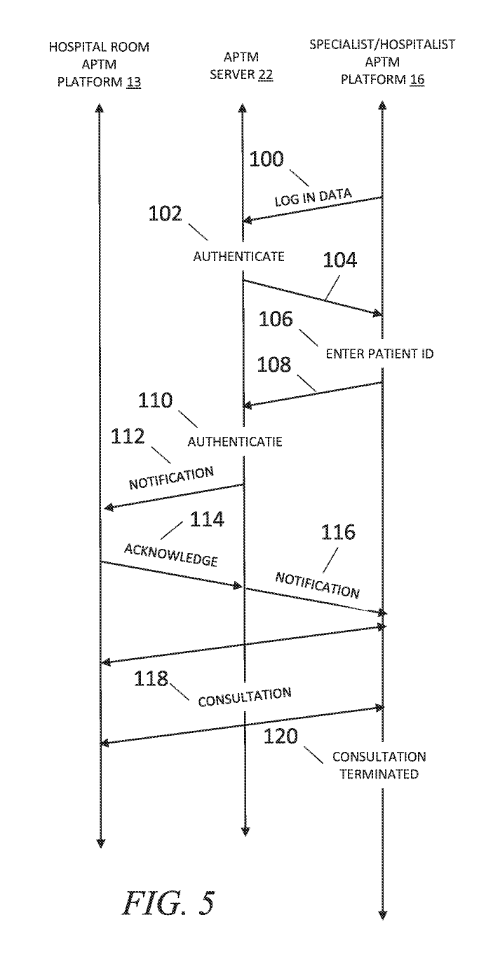

FIG. 5 is a simplified data flow diagram of an exemplary embodiment of an on-demand all-points telemedicine rounding method according to the teachings of the present disclosure. A physician may perform his hospital floor rounding function by using the APTM system 10. The physician may use a computing device of his choice that is capable of executing the APTM app. The physician first enters log-in information, such as user name, password, biometric data (e.g., fingerprint, facial recognition, and other methods now known or to be developed), and the log-in information is transmitted to the APTM server, 100. The APTM server 22 authenticates the log-in data, 102, and permits the physician to access the APTM system by transmitting APTM web portal pages to the physician's computing device, 104. The physician then inputs the patient's identity such as the patient's name, hospital room number, and/or other data that may be used to uniquely identify the patient, 106, which is transmitted to the APTM server, 108. The APTM server then authenticates the patient identification information, 110, and transmits a notification to the APTM equipment 13 in the patient's room, 112. The patient or a member of the medical staff may provide an acknowledgement for the APTM session, which is transmitted to the APTM server, 114, and sent as a notification back to the physician's APTM device, 116. Thereafter, a consultation session begins, 118, and can be terminated by either party when the session concludes, 120.

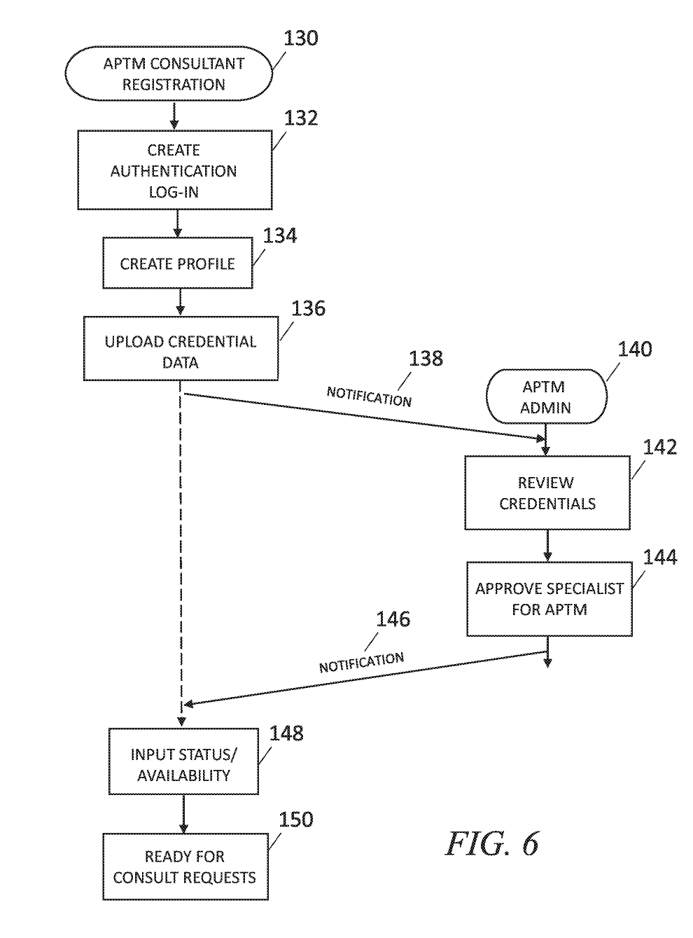

FIG. 6 is a simplified flowchart of an exemplary embodiment of an on-demand all-points telemedicine consultation registration method 130 according to the teachings of the present disclosure. A medical doctor with the proper credentials and certification may register with the on-demand APTM system 10. The doctor enters log-in authentication data, as shown in block 132. The doctor also creates a profile that provides details on his/her credentials and certification, as shown in block 134. The doctor further uploads credential and recommendation data to the APTM server, as shown in block 136. Upon registration of a new doctor, the APTM administrator 140 receives a notification, 138. The APTM administrator reviews the credentials of the doctor, and performs independent verification of the doctor's qualifications, as shown in block 142. If the doctor has the proper qualifications and satisfies all of the requirements to participate in APTM, the registration is approved, as shown in block 144. The approval is transmitted to the specialist as a notification, 146, which may be, e.g., an email, a text message, or a phone call. Thereafter, when the specialist has a block of time during which he/she would like to participate in on-demand APTM, he/she would enter his/her availability status, as shown in blocks 148 and 150. For example, the specialist may indicate that he/she will be available on-call for the next three hours, or between 3 pm and 7 pm. Alternatively, the specialist may enter calendar dates and times during which he/she has availability.

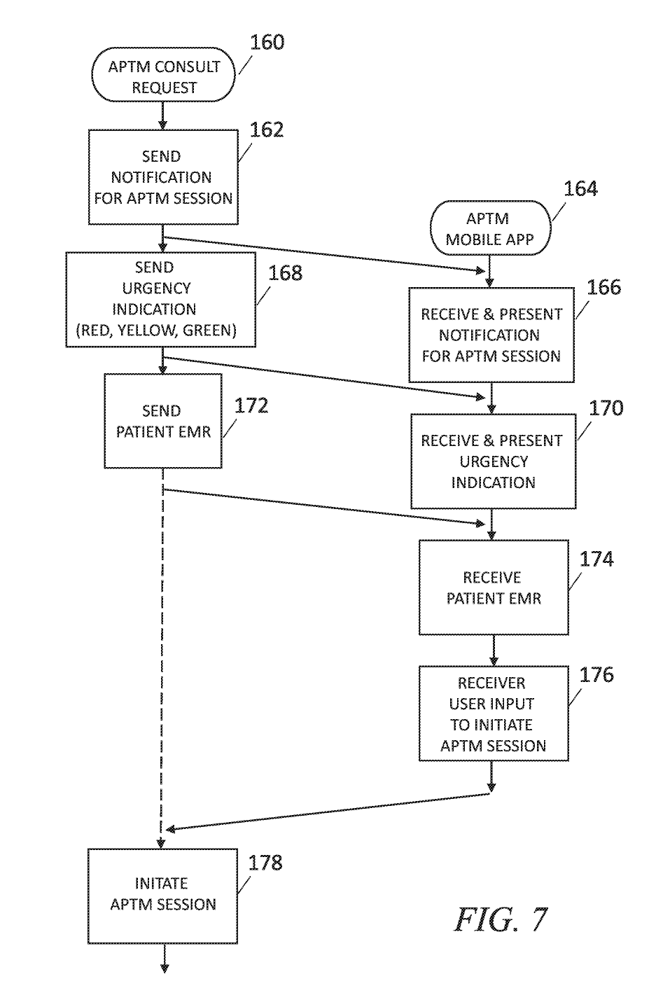

FIG. 7 is a simplified flowchart of an exemplary embodiment of a telemedicine consultation method 160 according to the teachings of the present disclosure. A medical staff, such as a staff RN, can call or send notification for a specialist consult, as shown in block 162. A specialist receives the notification via a mobile app 164 executing on a mobile computing device and displays the notification, as shown in 166. As a part of the notification or separately immediately following the initial notification, the medical staff also sends an urgency indicator to the specialist, as shown in block 168, which is also displayed, as shown in block 170. The urgency indicator provides information that reflects the urgency of request. The specialist can have different time frame to participate in the consultation session, depending on the urgency: red—respond ASAP, yellow—respond within 30 minutes, green—respond within one hour, and pink—call when you can, for example. The specialist may accept the on-demand APTM engagement by sending a response. Subsequently, the patient's EMR is pushed to the specialist, who reviews the information to prepare for the on-demand APTM consultation session, as shown in blocks 172 and 144. When the specialist is ready, he/she provides input via the APTM mobile app, as shown in block 176, and the APTM consultation session begins, as shown in block 178. If the request is designated as emergent and the consulting specialist does not respond in a timely manner, a protocol to call for an alternative specialist is activated to solicit the emergent response by another specialist.

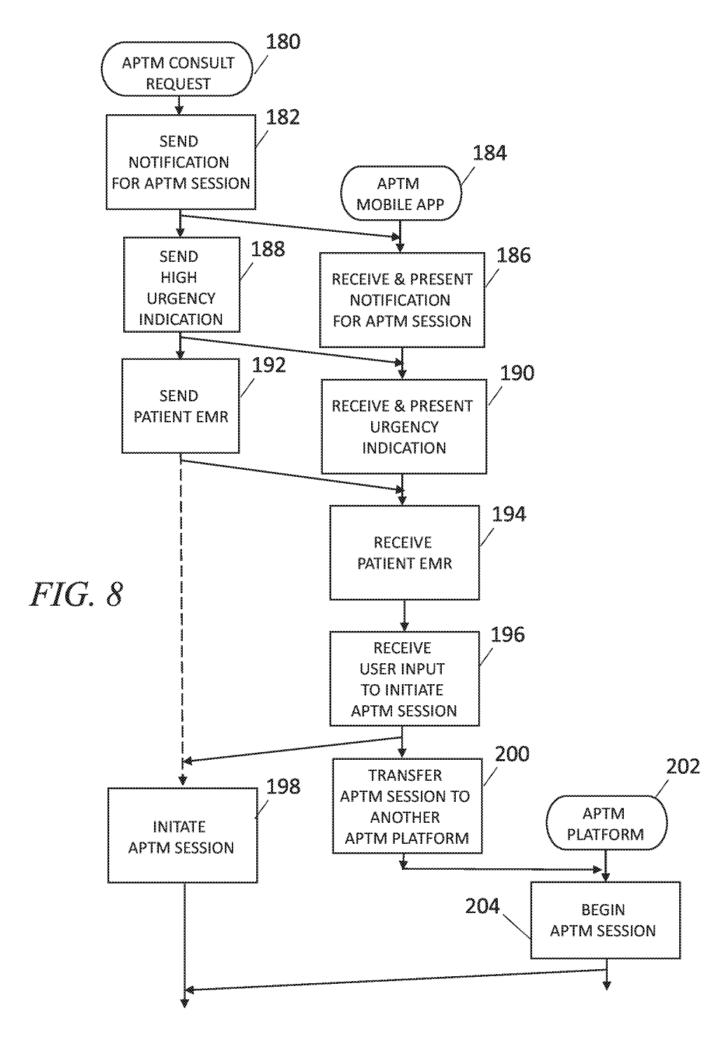

FIG. 8 is a simplified flowchart of another exemplary embodiment of a telemedicine consultation method 180 according to the teachings of the present disclosure. The end-user would have the flexibility to initiate an on-demand APTM session on a mobile device and then transfer to a laptop or an APTM equipment, for example, seamlessly and continue with the APTM consultation session. In block 182, a first user initiates an APTM consultation session and sends a notification to a second user such as a specialist consultant using a mobile device running an APTM mobile app 184. The notification is received and presented to the specialist on the screen of the mobile device, as shown in block 186. The first user also send a high urgency indicator, as shown in block 188, which is also received and presented at the specialist's end, 190. The patient's EMR is also transmitted to the specialist, as shown in block 192, which is also received by the mobile device and available for review by the specialist, as shown in block 194. The specialist may then indicate readiness to begin the consultation session, which is transmitted to the first user, as shown in block 196. The APTM session then begins, as shown in block 198. At some point during the consultation session, the specialist may transfer the APTM session to another APTM platform, as shown in block 200. As a result, a handover occurs, and the consultation session is handed to another APTM equipment, 202, and the APTM session continues, as shown in block 204. The handover session should be performed in a seamless manner without disrupting the communication of information between the two parties.

Because all hospital rooms are equipped for APTM equipment, the hospitalists, the specialists, and the RNs may see and engage with the patients face-to-face virtually in real-time to ensure the best care possible. The hospitalists may make the initial visit by APTM or revisit the patient in his/her room by APTM any time of the day. This enables the hospitalists/consultants to speak with different family members at different times of the day without having to physically return to the patient's room. Currently, the doctor makes rounds in the mornings just once a day—but the patient's condition can change very quickly—that's why there is a need for the patients to stay in the hospital as their condition may change. Some conditions do not warrant a doctor to come in while some emergent conditions do. If the decision on whether the doctor should come in or not was wrong, a bad outcome may occur as the patient's condition deteriorates. When a patient's condition changes, appropriate evaluations are indicated to offer the right recommendations. The patient's changing clinical condition cannot wait till the doctor sees the patient during the next scheduled visit.

Further, many doctors round at 6 or 7 AM which is difficult for patient's family members to be present. This means poor interpretation of quality of care received by the patient and his/her family. If the patient's family members miss seeing the doctor one day, it would be the next day before the doctor returns. With APTM, the doctors just have to physically round on inpatients, more as formality for the daily visit, at any time they want. They have already explained everything to the patient and family about the care for the day via APTM. This allows tremendous flexibility in the consultants' time management to be more productive elsewhere. With APTM, the doctor can make rounds in front of an iPad, with high efficiency—be able to beam in and out of patient's room in minutes as there would be no need to walk from room to room. The doctor can thus schedule more procedures or other duties in a single day. The consultants can eventually complete his face-to-face visits any time that is more convenient for the doctor later in the day instead of more convenient for the patient or patient's family.

The ability for the APTM system to allow the remote physician/consultant to “jump” from room to room with a simple click/stroke allows the doctor to engage a patient/doctor for a few minutes, then beam to a different room/different patient and doctor for few minutes and offer recommendations, then beam to another room to care for another patient, before beaming back to the original room to follow up on the patient. Since the specialists may need to physically care for certain patients, the doctor can be “on the move” and travel to the patient care locations where his hands-on care is needed. Again, the need for the doctor to be able to care for patients in different places while on-the-go is a key feature/advantage of APTM.

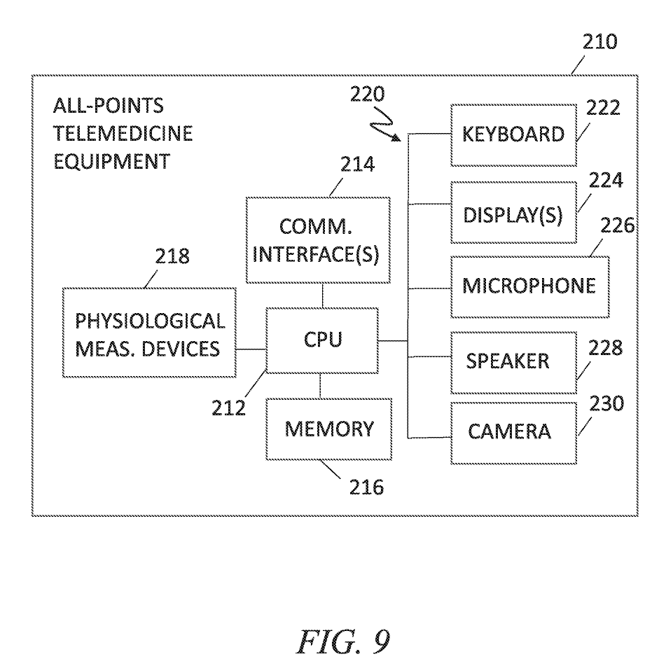

FIG. 9 is a simplified block diagram of an exemplary embodiment of telemedicine consultation and rounding equipment 180 according to the teachings of the present disclosure. The APTM equipment 210 includes one or more microcontrollers, microprocessor, or central processing unit 212, communication interfaces 214 for communication with remote devices/servers via the Internet, Local Area Network, WiFi router, cellular network, etc., and memory devices 216 to store data (which may be encrypted). The communication interfaces 214 is capable of establishing an encrypted communication channel with the web server and database server as well as other APTM equipment/devices. The CPU 212 is also preferably in communication with a variety of physiological measurement devices 218 configured for monitoring and measuring patient's physiological function, such as heart rate, blood pressure, blood oxygen content, body temperature, etc. These physiological measurement devices 218 may include thermometer, stethoscope, blood pressure monitor, hand-held camera, scope, etc. The equipment 210 further includes a variety of user interface devices 220, including keyboard (virtual or actual) 222, HD display(s) 224, microphone 226, speaker(s) 228. The APTM equipment 210 further includes a HD video camera 230 that is capable of capturing still and moving images, as well as focusing, zooming in and out, panning, and other camera functions by remote control. There are numerous innovative monitoring and examinations devices being developed that are compatible with APTM platform that are yet to be realized.

The on-demand APTM program can be started with just one APTM mobile cart/apparatus per patient care area to save costs at the start-up phase. With gradual expansion, it would be ideal to fit all patient rooms with APTM equipment. The remote examination peripheral device need not be present in every patient room. The peripheral device can be portable and brought into the room when necessary. Statistically, over 80% of on-demand APTM interactions would not require the peripheral devices to achieve its goals of consultation. The mobile telemedicine cart/apparatus can be stored at a central location at a patient-care area and be rolled/brought into any patient room that this service is warranted.

In the patient rooms, it makes the most sense by using the existing HD flat screen TV that is already in the patient's room to display the telepresence of the doctors, other medical staff, or family members on screen. There would be a HD camera that is located either on top or below the TV used for APTM. This HD Camera can offer wide angle view of the entire patient room so the camera does not need to shift position in order to visualize key areas in the room. The wide-angle HD camera screen can enlarge and focus anywhere in the room on the screen of a tablet, for example. Every important patient-monitors (telemetry monitors etc.) in the room is strategically placed to be clearly visible by the HD camera.

Although the on-demand APTM system and method 10 have been described in detail in the context of an ER physician requesting consult with a specialist, these system and method are also equally applicable to other scenarios with significant beneficial results. For example, a chiropractic clinic may employ certified chiropractors to address mechanical disorders of the patients' musculoskeletal system. Although chiropractors may manually and mechanically manipulate the patients' joints, muscles, and other soft tissues, most states do not permit chiropractors to prescribe medication. Whereas before chiropractic medicine has always existed in parallel to western medicine and viewed askance as “alternative” medicine, there are many patient ailments that are best addressed by combining chiropractic manipulation and pharmaceutical medicines. By deploying on-demand APTM, a chiropractic clinic may request physician consultation when a patient's condition warrants it, so that medicine can be prescribed by the physician if needed. In effect, the chiropractic office becomes a patient presenting site (PPS) as well that can tap into on-demand physicians and specialists. The use of on-demand APTM thus would greatly benefit patient outcome to efficiently and optimally address all of the patients' needs in a single visit. Moreover, the combined services of chiropractors and medical physicians using on-demand APTM can lower the overall costs for the patient and healthcare system.

In addition to the afore-mentioned applications, the APTM system 10 may be used by non-medical staff such as social workers to have follow-up visits with patients and family members about post-discharge arrangements.

The features of the present invention which are believed to be novel are set forth below with particularity in the appended claims. However, modifications, variations, and changes to the exemplary embodiments described above will be apparent to those skilled in the art, and the on-demand all-points telemedicine consultation and rounding system and method described herein thus encompasses such modifications, variations, and changes and are not limited to the specific embodiments described herein.

What is claimed is:

1. An on-demand all-points telemedicine (APTM) system for a patient presenting site, comprising:
a patient data server configured to store encrypted patient electronic medical records;
a web server configured to store a plurality of web pages of an all-points telemedicine consultation web portal;
a plurality of APTM equipment disposed in the emergency room and patient rooms, each including:
a microprocessor executing an APTM application;
a communication interface circuit in communication with the microprocessor and configured to interface with the patient data server and the web server using a variety of communication protocols to transmit and receive data, including video data, alphanumeric data, electronic medical record data, and control data;
a remotely-controllable video camera in communication with the microprocessor and configured to capture video and still images and sound;
a display screen in communication with the microprocessor and configured to display data and video and still images, play video audio data, display electronic medical record data;
a speaker in communication with the microprocessor and configured to play audio data and sound;
a microphone in communication with the microprocessor and configured to receive audio information; and
a user interface device configured to receive user input; and
a mobile app configured for execution on a mobile computing device and configured for communicating with the plurality of APTM equipment and the patient data server to exchange electronic medical records, still and video data, messages, and control data.

2. The system of claim 1, wherein the APTM equipment is selected from the group consisting of mobile telephone, tablet computer, laptop computer, desktop computer, and dedicated telemedicine equipment.

3. The system of claim 1, wherein the user interface device is selected from the group consisting of a keyboard, a touch screen, a pointing device, and a writing tablet.

4. An on-demand all-points telemedicine (APTM) method comprising:
receiving, from a plurality of physician users, registration information including log-in data, credential data, and profile data;
approving at least one of the plurality of physician users as registered physician users;
receiving, at an APTM equipment, a request from user 1 indicating a desire for on-demand all-points telemedicine session with a user having a specified specialty;
broadcasting the request and urgency indicator to an APTM mobile app running on at least one mobile device of at least one registered physician users having the specified specialty;
receiving authentication and acknowledgement from a plurality of registered physician users having the specified specialty;
presenting a recommendation of registered physician users having the specified specialty including availability information to user 1;
receiving a selection of a registered physician user having the specified specialty from user 1;
transmitting a notification of the selection to a user 2 who is the selected registered physician user having the specified specialty;
receiving an acceptance from user 2 to initiate the on-demand APTM consultation session;
establish encrypted video conference communication channel between the APTM equipment used by user 1 and the mobile device used by user 2; and
capturing and communicating encrypted video conference data over the established encrypted video conference communication channel between the APTM equipment and the mobile device.

5. The method of claim 4, wherein receiving a request from user 1 comprises receiving an urgency indicator, and receiving authentication and acknowledgement from a plurality of registered physician users comprises receiving availability information in response to the urgency indicator.

6. The method of claim 5, wherein presenting a recommendation of registered physician users comprises selecting registered physician users who is able to timely participate in a consultation session according to the urgency indicator.

7. The method of claim 4, wherein presenting a recommendation of registered physician users comprises selecting registered physician users who is able to immediately participate in a consultation session.

8. The method of claim 4, wherein receiving a request from user 1 comprises receiving, at an APTM equipment disposed at a patient presenting site selected from the group consisting of a free-standing emergency facility, a hospital emergency room, an urgent care clinic, a patient examination room, a chiropractic facility, a patient hospital room, a micro-hospital, and nursing home.

9. An on-demand all-points telemedicine (APTM) method comprising:
receiving, from a plurality of physician users, registration information including log-in data, credential data, and profile data;
approving at least one of the plurality of physician users as registered physician users;
receiving, at an APTM equipment, a request from user 1 indicating a desire for on-demand all-points telemedicine session with a user having a specified specialty and an urgency indicator;
broadcasting the request and urgency indicator to an APTM application running on at least one mobile device of at least one registered physician users having the specified specialty;
receiving authentication and acknowledgement from a plurality of registered physician users having the specified specialty including availability information;
presenting a recommendation of registered physician users having the specified specialty including availability information to user 1;
receiving a selection of a registered physician user having the specified specialty from user 1;
transmitting a notification of the selection to a user 2 who is the selected registered physician user having the specified specialty;
receiving an acceptance from user 2 to initiate the on-demand APTM consultation session;
establish a first encrypted video conference communication channel between the APTM equipment used by user 1 and the mobile device used by user 2;
capturing and communicating encrypted video conference data over the established encrypted video conference communication channel between the APTM equipment and the mobile device;
receiving and authenticating log-in data from user 2 at a second computing device running the APTM application;
enabling transferring the APTM session to the second computing device;
establish a second encrypted video conference communication channel between the APTM equipment and the second computing device;
capturing and communicating encrypted video conference data over the second established encrypted video conference communication channel between the all-points equipment and the second computing device; and
terminating the first encrypted video conference communication channel.

10. The method of claim 9, wherein presenting a recommendation of registered physician users comprises selecting registered physician users who is able to timely participate in a consultation session according to the urgency indicator.

11. The method of claim 9, wherein presenting a recommendation of registered physician users comprises selecting registered physician users who is able to immediately participate in a consultation session.

12. The method of claim 9, wherein receiving a request from user 1 comprises receiving, at an APTM equipment disposed at a patient presenting site selected from the group consisting of a free-standing emergency facility, a hospital emergency room, an urgent care clinic, a patient examination room, a chiropractic facility, a patient hospital room, a micro-hospital, and nursing home.

13. The method of claim 9, further comprising:
receiving log-in information from a user using a mobile device executing the APTM mobile app; and
transmitting to the mobile device web pages associated with an APTM web portal in response to authenticating the log-in information.

14. The method of claim 9, further comprising presenting profile data of the plurality of registered physician users having the specified specialty to user 1.

15. The method of claim 9, further comprising transmitting and presenting patient electronic medical records (EMR) to user 2 in response to transmitting a notification of the selection to user 2.

16. The method of claim 9, further comprising accessing a patient EMR database.

17. The method of claim 9, further comprising storing consultation session video data in an encrypted patient database.

18. The method of claim 9, further comprising storing registered physician user data in an encrypted database.
